(19) United States
(12) Patent Application Publication
(10) Pub. No.: US 2026/0094254 A1
(43) Pub. Date: Apr. 2, 2026

(54) VISION INSPECTION SYSTEM AND METHOD FOR VEHICLE MANUFACTURING

(71) Applicants: Hyundai Motor Company, Seoul (KR); Kia Corporation, Seoul (KR)

(72) Inventor: Min Joon Kim, Hwaseong (KR)

(21) Appl. No.: 18/959,315

(22) Filed: Nov. 25, 2024

(30) Foreign Application Priority Data
Oct. 2, 2024 (KR) 10-2024-0133496

(51) Int. Cl. G06T 7/00; G06V 10/764; G06V 10/776

(52) U.S. Cl. CPC G06T 7/0004; G06V 10/764; G06V 10/776; G06T 2207/20081

(57) ABSTRACT

A vision inspection system for vehicle manufacturing includes an appearance defect vision inspection apparatus configured to inspect appearance defects based on product image data captured by a camera, a data storage configured to store inspection data comprising the product image data and determination result data of an appearance defect inspection, and an AI retraining support inspection apparatus configured to identify incorrect determination data among the determination result data using teaching AI models based on the inspection data and the determination result data input from the data storage, and update the appearance defect vision inspection AI model of the appearance defect vision inspection apparatus through a model retraining process performed based on the identified incorrect determination data.

### CROSS-REFERENCE TO RELATED APPLICATION

This application claims under 35 U.S.C. § 119(a) the benefit of Korean Patent Application No. 10-2024-0133496 filed on Oct. 2, 2024, the entire contents of which are incorporated herein by reference.

### BACKGROUND

### (a) Technical Field

The present disclosure relates to a vision inspection system and method for vehicle manufacturing capable of automatically updating an artificial intelligence (AI) model that determines defects from vision inspection data during a vehicle manufacturing process.

### (b) Description of the Related Art

Painting defects, etc. may occur on a vehicle body that has undergone a painting process during an automobile manufacturing process, and it is necessary to quickly and accurately find such appearance defects before moving on to the next process.

Conventionally, such defects may be directly inspected and classified by a person, but recently, a vision inspection system that analyzes image data captured by a camera to determine defects has been introduced and utilized.

Furthermore, a machine vision system that applies a deep learning algorithm has been introduced recently and has thus greatly improved accuracy and efficiency of inspection.

However, since a deep learning model depends on training data, performance of the deep learning model may be deteriorated due to occurrence of new types of defects or environmental changes. In order to improve accuracy of inspection using the deep learning model, continuous model update and retraining are required, but it is very difficult for a person to manually select useful data from large amounts of inspection data.

FIG. 1 (PRIOR ART) is a diagram schematically showing a conventional vision inspection process. When inspection data, such as images captured by a vision camera, is acquired, an appearance defect vision inspection AI model determines whether there are defects and the defective states thereof based on the acquired inspection data, and then classifies such quality defects into defect types (e.g., Classes 01 to 10).

Next, a person directly determines quality defects with the naked eye using the inspection data, such as the images captured by the vision camera, and directly confirms whether there are any incorrect determinations for each defect type in the determination results by the appearance defect vision inspection AI model by comparing the visual determination results with the determination results by the appearance defect vision inspection AI model.

Thereafter, a person directly performs data labeling on the confirmed incorrect determination data, and the appearance defect vision inspection AI model is modified or updated using the results of the data labeling.

As such, deep learning-based appearance automatic inspection systems may greatly improve efficiency and accuracy of quality control in the manufacturing industry, but the processes, such as incorrect determination confirmation, data labeling, and AI model modification and update are all performed manually by people.

These conventional vision inspection systems and methods have the following problems.

First, data that deteriorates model performance is continuously generated due to various factors.

Second, large amounts of high-quality data is required to prevent performance degradation, but it is difficult to secure large amounts of high-quality data.

Third, when trying to use large amounts of data generated by the inspection system, it is realistically impossible for a person to manually select unsuitable data.

The above information disclosed in this Background section is only for enhancement of understanding of the background of the invention and therefore it may contain information that does not form the prior art that is already known in this country to persons of ordinary skill in the art.

### SUMMARY

The present disclosure provides an automatic vision inspection system and method that may automatically update an AI model that determines defects from vision inspection data using determination result data.

It is another object of the present disclosure to provide an automatic vision inspection system and method that may automatically analyze determination result data and effectively update a deep learning model using the determination result data of the deep learning model so as to improve inspection performance.

In one aspect, the present disclosure provides a vision inspection system including an appearance defect vision inspection apparatus configured to inspect appearance defects using an appearance defect vision inspection artificial intelligence (AI) model based on product image data captured by a vision camera, a data storage configured to store inspection data including the product image data used for the appearance defect inspection and determination result data of the appearance defect inspection by the appearance defect vision inspection AI model, and an AI retraining support inspection apparatus configured to identify incorrect determination data among the determination result data using teaching AI models based on the inspection data and the determination result data input from the data storage, and update the appearance defect vision inspection AI model of the appearance defect vision inspection apparatus through a model retraining process performed based on the identified incorrect determination data.

In a further aspect, a vision inspection system for vehicle manufacturing may include: an appearance defect vision inspection apparatus configured to inspect appearance defects using an appearance defect vision inspection artificial intelligence (AI) model based on product image data captured by a camera; a data storage configured to store inspection data comprising the product image data and determination result data of an appearance defect inspection; and an AI retraining support inspection apparatus configured to identify incorrect determination data among the determination result data based on the inspection data and the determination result data input from the data storage, and update the appearance defect vision inspection AI model of the appearance defect vision inspection apparatus through a model retraining process performed based on the identified incorrect determination data.

In a preferred embodiment, the AI retraining support inspection apparatus may include a teaching AI model unit configured to determine whether there are appearance defects of a product and defective states thereof based on the inspection data, acquire and identify the incorrect determination data based on determination results as to whether there are the appearance defects of the product and the defective states thereof and the determination result data by the appearance defect vision inspection apparatus input from the data storage, and correct the identified incorrect determination data.

In another preferred embodiment, the teaching AI models may include binary classification teaching AI models provided to acquire the incorrect determination data by determining whether determination results by the appearance defect vision inspection apparatus are incorrectly determined based on the determination results as to whether there are the appearance defects of the product and the defective states thereof by the teaching AI model unit and the determination result data by the appearance defect vision inspection apparatus, and identify the acquired incorrect determination data, and a multiclass classification teaching AI model configured to correct the identified incorrect determination data and assign a label for each defect type to actually defective data among the corrected data.

In still another preferred embodiment, the AI retraining support inspection apparatus may further include a data filtering unit configured to filter the identified incorrect determination data and actually defective data among the corrected data to construct a data set to be used for model retraining, and a model retraining unit configured to retrain and modify the appearance defect vision inspection AI model based on the data set constructed by the data filtering unit.

In yet another preferred embodiment, the AI retraining support inspection apparatus may further include a data preprocessing unit configured to receive the inspection data and the determination result data from the data storage and convert the inspection data and the determination result data into a form processible by the teaching AI models.

In still yet another preferred embodiment, the AI retraining support inspection apparatus may be provided to transmit the appearance defect vision inspection AI model modified through the model retraining process to the appearance defect vision inspection apparatus to update the appearance defect vision inspection AI model of the appearance defect vision inspection apparatus.

In another aspect, the present disclosure provides a vision inspection method including inspecting, by an appearance defect vision inspection apparatus, appearance defects using an appearance defect vision inspection artificial intelligence (AI) model based on product image data captured by a vision camera, transmitting inspection data including the product image data used for the appearance defect inspection and determination result data of the appearance defect inspection by the appearance defect vision inspection AI model to a data storage so that the data storage stores the inspection data and the determination result data, and identifying, by an AI retraining support inspection apparatus, incorrect determination data among the determination result data using teaching AI models based on the inspection data and the determination result data input from the data storage, and updating the appearance defect vision inspection AI model of the appearance defect vision inspection apparatus through a model retraining process performed based on the identified incorrect determination data.

A vehicle manufacturing assembly may include the vision inspection system.

In a further aspect, a vision inspection method for vehicle manufacturing may include: inspecting, by an appearance defect vision inspection apparatus, appearance defects using an appearance defect vision inspection artificial intelligence (AI) model based on product image data captured by a camera; transmitting inspection data comprising the product image data and determination result data of an appearance defect inspection to a data storage so that the data storage stores the inspection data and the determination result data; and identifying, by an AI retraining support inspection apparatus, incorrect determination data among the determination result data using teaching AI models based on the inspection data and the determination result data input from the data storage, and updating the appearance defect vision inspection AI model of the appearance defect vision inspection apparatus through a model retraining process performed based on the identified incorrect determination data.

In a preferred embodiment, the AI retraining support inspection apparatus may determine whether there are appearance defects of a product and defective states thereof based on the inspection data, acquire and identify the incorrect determination data based on determination results as to whether there are the appearance defects of the product and the defective states thereof and the determination result data by the appearance defect vision inspection apparatus input from the data storage, correct the identified incorrect determination data, and then perform the model retraining process using the identified incorrect determination data and the corrected data.

In another preferred embodiment, the teaching AI models may include binary classification teaching AI models provided to acquire the incorrect determination data by determining whether determination results by the appearance defect vision inspection apparatus are incorrectly determined based on the determination results as to whether there are the appearance defects of the product and the defective states thereof by the teaching AI retraining support inspection apparatus and the determination result data by the appearance defect vision inspection apparatus, and identify the acquired incorrect determination data, and a multiclass classification teaching AI model configured to correct the identified incorrect determination data and assign a label for each defect type to actually defective data among the corrected data.

In still another preferred embodiment, the AI retraining support inspection apparatus may filter the identified incorrect determination data and actually defective data among the corrected data to construct a data set to be used for model retraining, and retrain and modify the appearance defect vision inspection AI model based on the data set.

In yet another preferred embodiment, the AI retraining support inspection apparatus may receive the inspection data and the determination result data from the data storage, convert the inspection data and the determination result data into a form processible by the teaching AI models, and then use the converted data in the teaching AI models.

In still yet another preferred embodiment, the AI retraining support inspection apparatus may transmit the appearance defect vision inspection AI model modified through the model retraining process to the appearance defect vision inspection apparatus to update the appearance defect vision inspection AI model of the appearance defect vision inspection apparatus.

A vehicle manufacturing method may include the vision inspection method.

Other aspects and preferred embodiments of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 (PRIOR ART) is a block diagram schematically showing a conventional vision inspection process;

FIG. 2 is a block diagram showing main components of a vision inspection system according to the present disclosure;

FIG. 3 is a flowchart showing a vision inspection method according to the present disclosure;

FIG. 4 is a diagram schematically showing a vision inspection process according to the present disclosure;

FIG. 5 is a diagram schematically showing a state in which a binary classification teaching AI model of a teaching AI model unit of the present disclosure is operated;

FIG. 6 is a diagram schematically showing a state in which a multiclass classification teaching AI model of the teaching AI model unit of the present disclosure is operated; and

FIGS. 7 to 10 are diagrams comprehensively showing a detailed process and data flow performed by the teaching AI model unit of the present disclosure.

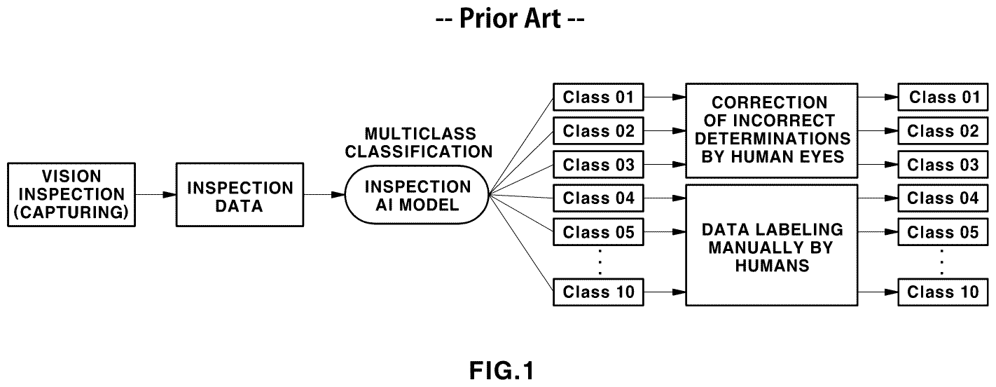

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, embodiments of the present disclosure will be described in detail with reference to the accompanying drawings. Specific structural or functional descriptions set forth in the embodiments of the present disclosure will be merely exemplarily given to describe the embodiments depending on the concept of the present disclosure, and the embodiments depending on the concept of the present disclosure may be embodied in different forms. Further, the present disclosure should not be construed as being limited to the embodiments set forth herein, and it will be understood that the present disclosure includes all modifications, equivalents, or substitutes included in the spirit and technical scope of the disclosure.

In the following description of the embodiments, terms, such as “first” and “second,” and the like, are used only to describe various elements, and these elements should not be construed as being limited by these terms. These terms are used only to distinguish one element from other elements. For example, a first element described hereinafter may be termed a second element, and similarly, a second element described hereinafter may be termed a first element, without departing from the scope of the disclosure.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present. Other words used to describe relationships between elements should be interpreted in a like fashion, e.g., “between” versus “directly between,”“adjacent”versus “directly adjacent,”etc.

Wherever possible, the same reference numbers will be used throughout the following description to refer to the same or like parts. The terminology used herein is for the purpose of describing particular embodiments only and is not intended to be limiting. As used herein, singular forms may be intended to include plural forms as well, unless the context clearly indicates otherwise. The terms “comprises,” “comprising,” “including,” and “having” are inclusive and therefore specify the presence of stated features, integers, operations, operations, elements, components, and/or combinations thereof, but do not preclude the presence or addition of one or more other features, integers, operations, operations, elements, components, and/or combinations thereof.

The present disclosure relates to a vision inspection system and method that may automatically inspect for defects in the appearance of a vehicle body that has undergone a painting process, etc., in the manufacturing industry, particularly in the automobile manufacturing industry, using artificial intelligent (AI) technology.

Particularly, the present disclosure aims to provide a vision inspection system and method that may automatically analyze detected data and effectively update a deep learning model using the determination result data of the deep learning model, thereby being capable of improving inspection performance.

The vision inspection system and method according to the present disclosure are useful for automatically inspecting and determining defects in the appearance of a vehicle body based on image information captured by a vision camera during the automobile manufacturing process.

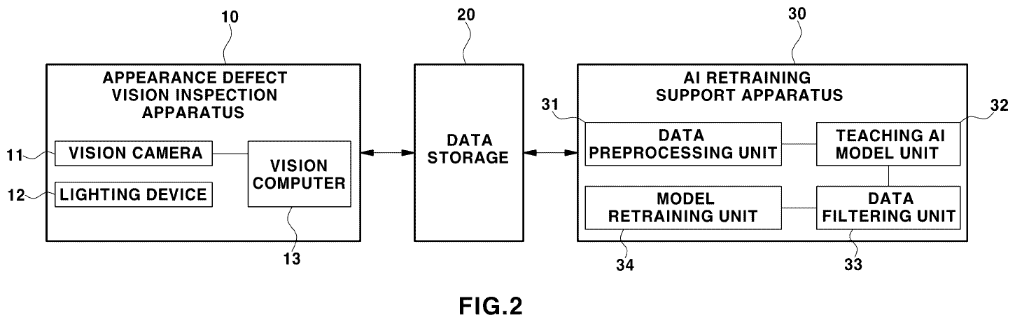

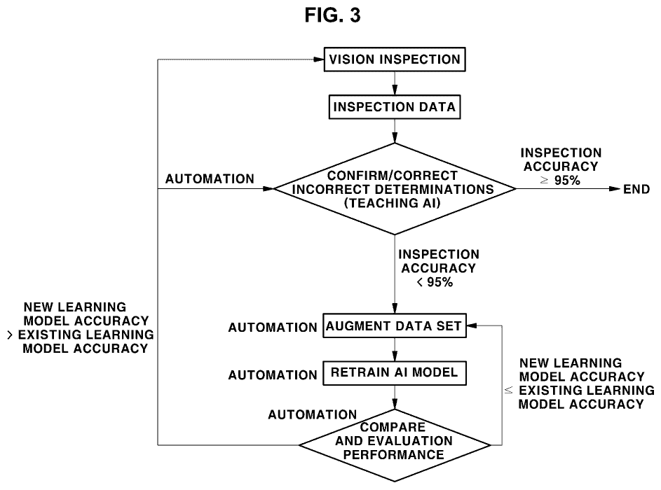

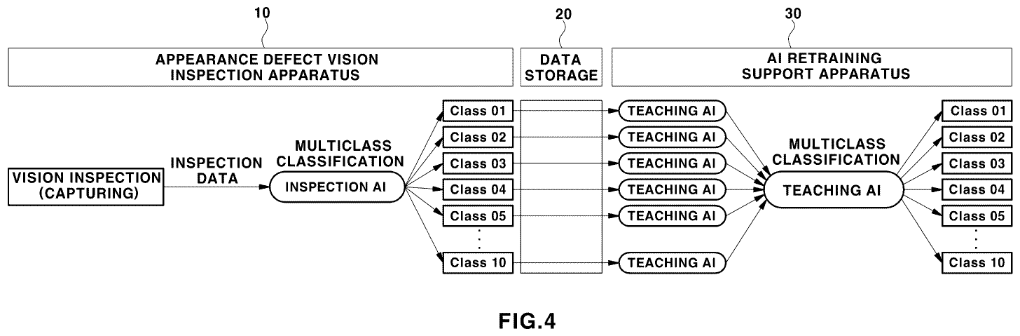

FIG. 2 is a block diagram showing main components of a vision inspection system according to the present disclosure, FIG. 3 is a flowchart showing a vision inspection method according to the present disclosure, and FIG. 4 is a diagram schematically showing a vision inspection process according to the present disclosure.

The vision inspection system according to the present disclosure includes an appearance defect vision inspection apparatus 10 that inspects for appearance defects using an AI model, and a data storage 20 in which inspection data, such as image data used in the appearance defect inspection, and determination result data of the appearance defect inspection are stored.

In addition, the vision inspection system according to the present disclosure further includes an artificial intelligence (hereinafter referred to as “AI”) retraining support apparatus 30, and the AI retraining support apparatus 30 determines whether there are incorrect determinations in determination results of the appearance defect inspection performed by the AI model of the appearance defect vision inspection apparatus 10 based on the inspection data and the determination result data input from the data storage 20.

Further, the AI retraining support apparatus 30 identifies and classifies the incorrect determination data acquired by determining whether there are incorrect determinations in the determination results, modifies the AI model using the classified incorrect determination data, and transmits and distributes the modified AI model to the appearance defect vision inspection apparatus 10 to update the AI model of the appearance defect vision inspection apparatus 10.

In the vision inspection system according to the present disclosure, the above components are provided to be interconnected and operated together so as to improve the performance of the AI model of the appearance defect vision inspection apparatus 10 in a continuous and automated manner.

Among the above components, the appearance defect vision inspection apparatus 10 serves to acquire images of the appearance of a product, determine whether there are defects in the product appearance based on the acquired image information using a deep learning-based AI model (hereinafter referred to as the “appearance defect vision inspection AI model), and classify quality defects into set types (Classes 01-10).

The appearance defect vision inspection apparatus 10 includes a high-resolution vision camera 11 configured to capture a product image, and a vision computer 13 equipped with software configured to process the images captured by the vision camera 11 and perform AI inference. In addition, the appearance defect vision inspection apparatus 10 may further include a lighting device 12 that provides lighting required for image capturing.

In the present disclosure, when a product to be inspected, for example, a vehicle body that has completed the painting process, passes through the appearance defect vision inspection apparatus 10, product images are obtained by capturing the appearance of the product from various angles by the vision camera 11.

Image data acquired in this way, that is, the inspection data acquired through vision inspection, is input to the vision computer 13, and is used as an input variable of the appearance defect vision inspection AI model in the software installed in the vision computer 13.

The appearance defect vision inspection AI model analyzes the image data acquired by the vision camera 11 (i.e., “inspection data” in FIGS. 3 and 4) to determine whether there are defects and the defective states thereof, and classifies such quality defects into defect types (Classes) based on the determination results. The determination results are used in quality management decision-making for the corresponding product.

Among the components, the data storage 20 serves to store all data generated by the appearance defect vision inspection apparatus 10, i.e., the inspection data, such as the product images serving as the model input variable, and determination result data for the inspection data by the appearance defect vision inspection AI model.

The data storage 20 may be a general large-capacity storge server, and supports systematic management and search of data through an internal database management system (not shown). Data accumulated in the data storage 20 is used as core data for AI retraining.

Among the components, the most essential component for AI retraining is the AI retraining support apparatus 30. The AI retraining support apparatus 30 may be a separate computer system equipped with software executed to implement teaching AI that will be described below

Conventionally, the entirety of the processes of confirming whether there are incorrect determinations in determination result data determined and generated by the appearance defect vision inspection AI model, correcting the incorrect determinations, and performing data labeling was performed manually by people.

However, in the present disclosure, the AI retraining support apparatus 30 automatically performs confirms whether there are incorrect determinations, corrects incorrect determination data, and performs automatic data labeling in which labels are automatically assigned to actually defective data among the corrected data using teaching AI models.

The AI retraining support apparatus 30 continuously monitors and analyzes the determination result data accumulated in the data storage 20 to automatically identify data that causes performance degradation of the appearance defect vision inspection AI model.

Specifically, the AI retraining support apparatus 30 may be configured to include the following sub-components.
1) Data preprocessing unit 31: serves to read the inspection data and the determination result data from the data storage 20, and convert the data into a form processible by the teaching AI models. This includes tasks, such as image size adjustment and normalization of captured images, etc.
2) Teaching AI model unit 32: has a plurality of teaching AI models, and each model is specialized for a specific type of defect. These models receive data preprocessed by the data preprocessing unit 31 and reevaluate the determination results by the appearance defect vision inspection AI model. Thereby, the teaching AI model unit 32 identifies incorrect determinations, i.e., incorrect determination data that is actually defective (as results of reevaluation) but is determined as being normal (“False Negative”) and incorrect determination data that is actually normal (as results of reevaluation) but is determined as being defective (“False Positive”).
3) Data filtering unit 33: filters the incorrect determination data identified and the redetermined data corrected by the teaching AI model unit 32 to construct a high-quality data set to be used for retraining. In this process, tasks, such as redundant data removal and noise removal data, may be performed.
4) Model retraining unit 34: retrains the appearance defect vision inspection AI model using the data set filtered by the data filtering unit. Such retraining may be performed by fine-tuning weights of the existing appearance defect vision inspection AI model, and have the effect of continuously improving the performance of the model.

The above components are organically interconnected in the following flow to be operated. In the present disclosure, the AI retraining support apparatus 30 may be directly connected to the appearance defect vision inspection apparatus 10 as well as the data storage 20 so as to exchange data therewith, or be indirectly connected to the appearance defect vision inspection apparatus 10 through the data storage 20.

In the present disclosure, the inspection data generated by the appearance defect vision inspection apparatus 10 is continuously accumulated in the data storage 20, and the AI retraining support apparatus 30 periodically reads the data accumulated in the data storage 20 for AI retraining and preprocesses the data through the data preprocessing unit 31.

The data (the inspection data and the determination result data) preprocessed by the data preprocessing unit 31 is transmitted to the teaching AI model unit 32, and the teaching AI model unit 32 determines whether there are incorrect determinations in the determination results of the appearance defect inspection performed by the AI model of the appearance defect vision inspection apparatus 10 based on the inspection data and the determination result data, and identifies the incorrect determination data.

The identified data is processed into a form suitable for retraining through the data filtering unit 33, and is finally utilized for updating the appearance defect vision inspection AI model and improving the performance thereof by the model retraining unit 34.

This series of processes is completely automated and may be continuously performed without human intervention. However, an interface (not shown) that may monitor and adjust step-by-step results depending on user needs may be provided. This allows system autonomy and user controllability to be balanced.

In the present disclosure, as shown in FIG. 3, the AI retraining support apparatus 30 may be set to terminate the series of processes for AI retraining if the determination accuracy (the ratio of incorrect determinations to normal determinations) of the appearance defect inspection performed by the appearance defect vision inspection AI model of the appearance defect vision inspection apparatus 10 is greater than or equal to a set value (e.g., 95%).

Further, as shown in FIG. 3, the AI retraining support apparatus 30 continues to perform the series or processes for AI retraining if the accuracy of a modified model is lower than or equal to the accuracy of the existing model, but transmits and distributes the modified model to the appearance defect vision inspection apparatus 10 to update the appearance defect vision inspection AI model with the modified model if the accuracy of the modified model is higher than the accuracy of the existing model.

For this purpose, the AI retraining support apparatus 30 classifies the identified incorrect determination data among the determination result data using the teaching AI models based on the inspection data and the determination result data input from the data storage 20, modifies the AI model using the classified incorrect determination data, and transmits and distributes the modified model to the appearance defect vision inspection apparatus 10 to update the AI model of the appearance defect vision inspection apparatus 10 with the modified AI model.

In summary, the AI retraining support apparatus 30 of the present disclosure is operated in conjunction with two core components, i.e., the appearance defect vision inspection apparatus 10 and the data storage 20, and it is possible to continuously and automatically update the appearance defect vision inspection AI model and improve the performance of the appearance defect vision inspection AI model through an organic data flow among these components.

Therefore, a new type of vision inspection system and method that improve the existing manual and inefficient AI model management method may be provided.

In the vision inspection system according to one embodiment of the present disclosure, the AI retraining support apparatus 30 has a complicate structure, but the core thereof is a series of AI models called the teaching AI models. These models serve to monitor and correct the determination results of the existing appearance defect vision inspection AI model.

Hereinafter, the structures and operating principles of the teaching AI models will be described in detail.

The teaching AI models may include two types of models. That is, the teaching AI models may include a binary classification teaching AI model for each defect type and a multiclass classification teaching AI model.

In the present disclosure, the appearance defect vision inspection AI model is a model that primarily determines whether there are defects based on the inspection data, such as images, and classifies determination result data.

On the other hand, among the teaching AI models in the present disclosure, the binary classification teaching AI models are models that determine quality defects based on the inspection data, compares the determination results with determination result data determined and classified by the appearance defect vision inspection AI model to examine whether there are incorrect determinations in the determination results by the appearance defect vision inspection AI model, and identifies incorrect determination data.

In addition, among the teaching AI models in the present disclosure, the multiclass classification teaching AI model may be a model that corrects the incorrect determination results based on the identified incorrect determination result.

Since each binary classification teaching AI model may be specialized for a specific defect type, i.e., a binary classification teaching AI model may be provided for each defect type, a plurality of binary classification teaching AI models may be provided and used. For example, there may be a model specialized for defect A, a model specialized for defect B, etc.

Each of these models compares the determination results made by the appearance defect vision inspection AI model with actual correct labels, and identifies incorrect determinations for a corresponding defect type, i.e., “False Positive” (data that is actually normal but is determined as being defective) and “False Negative” (data that is actually defective but is determined as being normal).

In the present disclosure, the AI model of the appearance defect vision inspection apparatus 10 (i.e., the appearance defect vision inspection AI model) and the multiclass classification teaching AI model of the AI retraining support apparatus 30 may be configured identically (e.g., the Resnet model, the EfficientNet model, or the like), or be configured differently.

However, the AI model of the appearance defect vision inspection apparatus 10 (i.e., the appearance defect vision inspection AI model) and the multiclass classification teaching AI model of the AI retraining support apparatus 30 may not be configured identically to the binary classification teaching AI model (e.g., ResNet, EfficientNet, or the like). However, they may be designed with the same architecture, except for a difference between binary classification and multiclass classification.

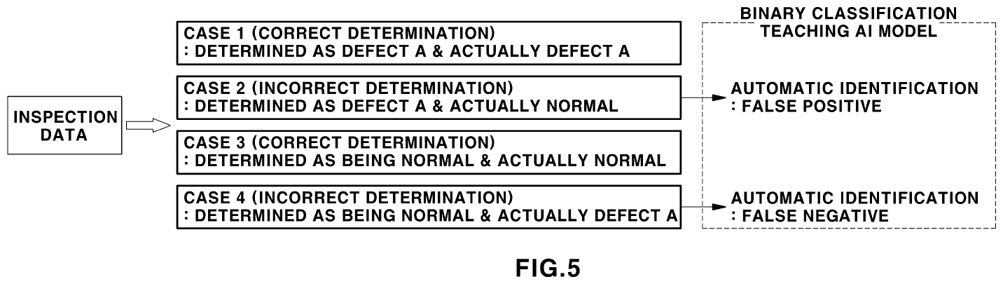

FIG. 5 is a diagram schematically showing a state in which the binary classification teaching AI model of the teaching AI model unit of the present disclosure is operated.

The determination result data generated by the appearance defect vision inspection AI model of the appearance defect vision inspection apparatus 10 is continuously accumulated in the data storage 20, and the AI retraining support apparatus 30 periodically reads the determination result data accumulated in the data storage 20 and preprocesses the determination result data through the data preprocessing unit 31.

The data preprocessed by the data preprocessing unit 31 is transmitted to the teaching AI model unit 32 to identify incorrect determination data, and among the teaching AI models in the teaching AI model unit 32, the binary classification teaching AI models receive the data preprocessed by the data preprocessing unit 31, reevaluate the determination results by the appearance defect vision inspection AI model, and therethrough automatically identify incorrect determinations, i.e., incorrect determination data of “False Negative” (data that is actually defective but is determined as being normal) or incorrect determination data of “False Positive”(data that is actually normal but is determined as being defective).

Referring to FIG. 5, a case in which the appearance defect vision inspection AI model determines data as defect A and the data is actually defect A, and a case in which the appearance defect vision inspection AI model determines data as being normal and the data is actually normal are correct determinations.

On the other hand, in the embodiment of FIG. 5, incorrect determination data of “False Positive” that the appearance defect vision inspection AI model determines as defect A but is actually normal, and incorrect determination data of “False Negative” that the appearance defect vision inspection AI model determines as being normal but is actually defect A are identified and classified by operation of the binary classification teaching AI model.

In the above manner, the binary classification teaching AI models specialized for respective defect types examine the determination results of the existing appearance defect vision inspection AI model, and identify incorrect determinations.

The identified data is processed into the form suitable for retraining through the data filtering unit 33, and is finally utilized for updating the appearance defect vision inspection AI model and improving the performance thereof by the model retraining unit 34.

Next, the multiclassification teaching AI model serves to receive the incorrect determination data identified by the binary classification models, correct the data into normal or defective (i.e., corrects the incorrect determinations), and redetermine the exact defect types for actually defective data.

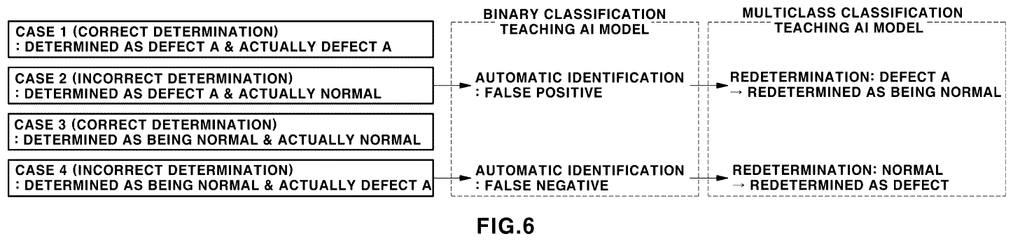

FIG. 6 is a diagram schematically showing a state in which the multiclass classification teaching AI model of the teaching AI model unit of the present disclosure is operated.

Referring to FIG. 6, it may be seen that a case in which data is determined as defect A but is actually normal is identified as an incorrect determination of “False Positive” by the binary classification teaching AI model, but this incorrect determination data is redetermined as being normal again by the multiclass classification teaching AI model that received the incorrect determination data from the binary classification teaching AI model.

Likewise, it may be seen that a case in which data is determined as being normal but is actually defect A is identified as an incorrect determination of “False Negative” by the binary classification teaching AI model, but this incorrect determination data is redetermined as defect A again by the multiclass classification teaching AI model that received this incorrect determination data from the binary classification teaching AI model.

Consequently, in the teaching AI model unit 32, the teaching AI models may comprehensively monitor and correct the determination results by the appearance defect vision inspection AI model through the hierarchical structure of the above-described binary classification teaching AI models and multiclass classification teaching AI model.

That is, in the teaching AI model unit 32, the binary classification teaching AI models primarily identify incorrect determination data, and the multiclass classification teaching AI model redetermines the incorrect determination data identified by the binary classification teaching AI models, and then assigns accurate labels to actually defective data.

The data identified and corrected by the teaching AI models in this way passes through the data filtering unit 33 to be finally configured as a retraining data set, and the data set is used to retrain the appearance defect vision inspection AI model by the model retraining unit 34, thereby continuously improving model performance.

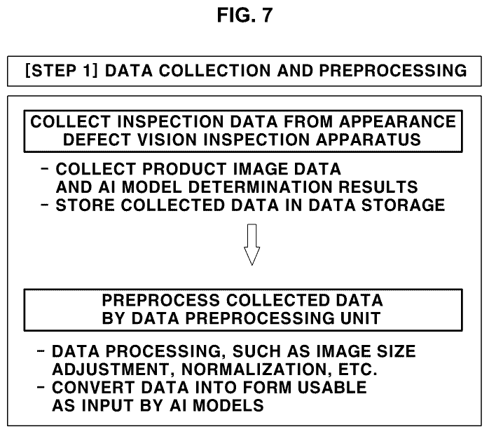

FIGS. 7 to 10 are diagrams comprehensively showing a detailed process and data flow performed by the teaching AI model unit of the present disclosure.

As shown in these figures, in the present disclosure, the appearance defect vision inspection apparatus 10 inspects and determines the appearance condition of a vehicle using the appearance defect vision inspection AI model based on image information captured by the vision camera 11, and determination result data is stored in the data storage 20.

Thereafter, the AI retraining support apparatus 30 receives the determination result data stored in the data storage 20, and the teaching AI model unit 32 of the AI retraining support apparatus 30 automatically identifies incorrect determination data using the binary classification teaching AI models, redetermines the identified incorrect determination data using the multiclass classification teaching AI model, and then assigns accurate labels to actually defective data.

As such, in the present disclosure, the determination results by the appearance defect vision inspection AI model are continuously monitored and improved using the detailed configuration, i.e., the teaching AI models, of the AI retraining support apparatus 30 through the above-described process.

This is an innovative method that may automatically improve the performance of the AI model without separate human intervention, and it is expected that the system and method of the present disclosure will further improve the efficiency and accuracy of quality management in the manufacturing industry.

In the present disclosure, the AI retraining support apparatus 30 is operated in the following steps. The details and data flow in each step will be described below with reference to FIGS. 7 to 10.

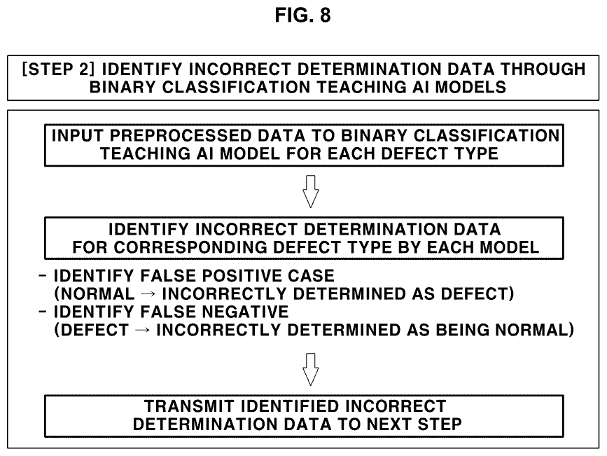

FIGS. 7 and 8 are diagrams showing the data collection and preprocessing process and the incorrect determination data identification process through the binary classification teaching AI models, performed in the AI retraining support apparatus 30 according to the present disclosure.

As shown in these figures, the data preprocessing unit 31 of the AI retraining support apparatus 30 reads data generated by the appearance defect vision inspection apparatus 10 from the data storage 20. For example, the data preprocessing unit 31 reads product image data (inspection data), which is image information captured by the vision camera 11, and determination result data by the appearance defect vision inspection AI model from the data storage 20.

Accordingly, the data preprocessing unit 31 preprocesses the inspection data read from the data storage 20, and in this case, performs data processing such as image size adjustment and normalization on the inspection data collected during the preprocessing process, and converts the inspection data into a form that is usable as input for the teaching AI models.

Thereafter, the teaching AI model unit 32 receives the preprocessed data from the data preprocessing unit 31, and in the teaching AI model unit 32, the preprocessed data is input into the binary classification teaching AI model for each defect type.

The binary classification teaching AI models identify incorrect determination cases by the existing appearance defect vision inspection apparatus 10, i.e., incorrect determination cases of “False Negative” in which defective data is incorrectly determined as being normal, and incorrect determination cases of “False Positive” in which normal data is incorrectly determined as being defective.

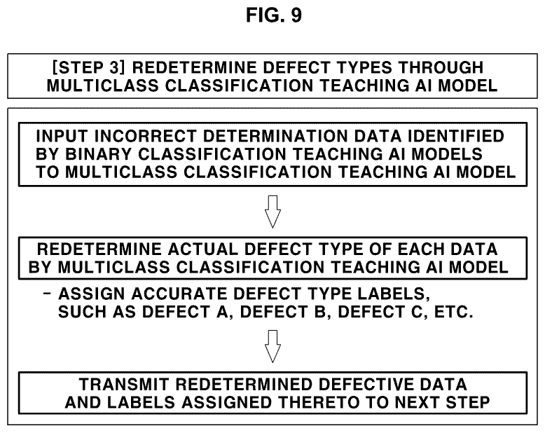

Among the identified incorrect determination cases, incorrect determination data of “False Negative”, that is, incorrect determination data that is actually defective but is determined as being normal, is input to the multiclass classification teaching AI model, as shown in FIG. 9.

Therefore, the multiclass classification teaching AI model redetermine each identified incorrect determination data, and assigns each of accurate defect type labels (“Class 01 - 10” in FIG. 4) to actually defective data. For example, the accurate defect type labels, such as defect A, defect B, defect C, etc., are assigned to the incorrect determination data.

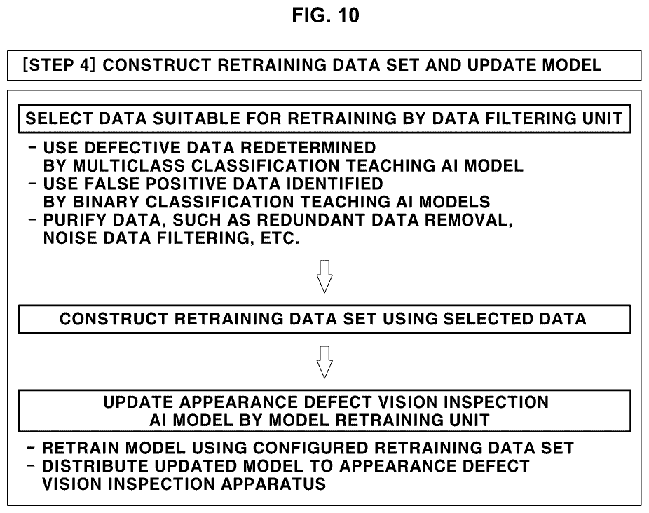

The redetermined incorrect determination data and the assigned labels are transmitted to a retraining data set construction and model update step, as the final step, as shown in FIG. 10.

In the final step, the data filtering unit 33 selects data suitable for retraining based on the incorrect determination data of “False Negative” and “False Positive” identified by the binary classification teaching AI models and the defective data redetermined by the multiclass classification teaching AI model, thereby configuring a high-quality data set. In this process, filtering and data purification, such as redundant data removal and noise data removal, may be performed.

The data set constructed in this way is used to update the existing appearance defect vision inspection AI model by the model retraining unit 34, the updated appearance defect vision inspection AI model is input and distributed to the vision computer 13 of the appearance defect vision inspection apparatus 10 and used in the appearance defect vision inspection apparatus 10, and therefore, further improved inspection performance may be achieved.

This series of processes is sequentially performed depending on the data flow, and according to the above series of processes, the performance of the appearance defect vision inspection AI model may ultimately be improved. Each step is implemented by an independent module, and the performance of the individual modules may be improved or new modules may be added, as needed.

In addition, the series of processes is designed so that the entirety of the processes may be automatically repeated without human intervention. However, an interface through which a system operator may monitor the results of each step and adjust parameters, etc., as needed may be provided, thereby being capable of considering system flexibility and user friendliness together.

The AI retraining support apparatus 30 of the present disclosure may overcome the limitations of existing appearance defect vision inspection devices, enable continuous performance improvement, and contribute to advancing the quality management paradigm of the manufacturing industry to the next level through the above-described systematic operation mechanism.

The AI retraining support apparatus 30 of the present disclosure may be utilized in various manufacturing industries. In addition to application examples in the automobile manufacturing industry, it may be applied in a similar manner in various manufacturing industries of electronics, food, clothing, etc.

For example, Company A, which is a smartphone manufacturing company, may introduce the present disclosure to improve the quality management efficiency of a factory thereof. A deep learning-based vision inspection system is used for appearance inspection of smartphones, but continuous model updates are required due to release of a new model or changes in the manufacturing process. Therefore, accordingly, Company A may use the AI relearning support apparatus 30 of the present disclosure that is customized to the vision inspection system thereof.

In the case of Company A, types of smartphone appearance defects may be different from vehicle paint defects. For example, scratches, discoloration, and assembly defects may be the main types of defects. Accordingly, Company A may develop binary classification teaching AI models specialized for these types of defects, and apply the binary classification teaching AI models to modules.

In addition, an inspection rate may be very important due to the characteristics of a smartphone production line. Accordingly, Company A may optimize the inspection rate using model weight reduction or hardware acceleration technology.

Some of the components of the present disclosure may be replaced. For example, the binary classification AI models and the multiclass classification AI model of the teaching AI model unit 32 may be replaced with other types of AI models. Various deep learning architectures, such as ResNet, InceptionNet, and EfficientNet, may be utilized depending on the manufacturing environment or defect characteristics. In addition, the function of the data filtering unit 33 may be integrated into the data preprocessing unit 31 or the model retraining unit 34. This may be determined in consideration of the convenience or efficiency of implementation.

As another modified example, it is also possible to provide the AI retraining support apparatus 30 of the present disclosure as a cloud-based service. In this case, manufacturers may easily utilize the AI retraining function through cloud services without developing their own modules.

Cloud service providers may develop a more robust teaching AI model by collecting data from various manufacturers, thereby being capable of continuously improving the quality of the services.

It is expected that the present disclosure will greatly contribute to advancement of AI utilization in the manufacturing industry. The value of the present disclosure may be further expanded through application and modification in various industrial fields. In addition, it is expected that the components of the present disclosure will be continuously upgraded as AI technology develops.

The AI retraining support apparatus 30 of the present disclosure has the effect of overcoming the limitations of conventional appearance defect vision inspection systems and innovatively improving efficiency and accuracy of quality management in the manufacturing industry.

In this way, the automatic vision inspection system and method according to the present disclosure have been described in detail, and the above-described automatic vision inspection system and method according to the present disclosure have the following effects.

First, the present disclosure enables continuous performance improvement of the appearance defect vision inspection model. In conventional systems, large-scale manual data labeling work was required to solve the performance degradation problem of an AI model.

However, in the present disclosure, since this work is automated by the teaching AI models, efficient processing of large-scale data is possible. In addition, since it is possible to quickly detect and respond to performance degradation of the AI model, continuous performance improvement of the AI model is possible.

Second, the present disclosure significantly improves accuracy of defect detection. The teaching AI models correct the determination results by the existing appearance defect vision inspection AI model, thereby minimizing the incorrect determination of “False Negative” in which actually defective data is incorrectly determined as being normal and the incorrect determination of “False Positive” in which actually normal data is incorrectly determined as being defective.

Particularly, the teaching AI models (the binary classification teaching AI models and the multiclass classification teaching AI model) with the hierarchical structure maximize accuracy of defect detection by combining specialization for each defect type and comprehensive determination.

Third, the present disclosure ensures consistency and objectivity of inspection results. In the conventional systems, there were problems that the inspection criteria were ambiguous or the inspection results varied depending on the skill of an inspector.

However, the AI retraining support apparatus of the present disclosure may minimize deviations of the inspection results because the AI retraining support apparatus is automatically operated depending on consistent criteria. This increases reliability of product quality and contributes to establishment of an objective quality management system.

Fourth, the present disclosure significantly reduces manpower and time through automation of inspection work. Existing manual inspection or large-scale data labeling work required a huge amount of manpower and time.

However, the AI retraining support apparatus of the present disclosure may significantly reduce manpower and time through automation of such work. This leads to improved productivity and cost reduction, thereby contributing to strengthening competitiveness of manufacturers.

Fifth, the present disclosure provides a flexible and expandable structure. The AI retraining support apparatus incudes independent functional units, i.e., the data preprocessing unit, the teaching AI model unit, the data filtering unit, and the model retraining unit, and thus, each unit may be easily replaced or performance of each unit may be easily improved.

In addition, even if a new type of defect or product line is added, a flexible response thereto is possible by updating only a corresponding part. Thereby, it is possible to quickly and effectively respond to changes in the manufacturing environment.

Finally, sixth, the present disclosure contributes to increasing AI utilization in the manufacturing industry as a whole. The AI retraining support apparatus may function as a kind of infrastructure for AI utilization in the manufacturing industry.

By utilizing the present disclosure in various manufacturing fields, accessibility and utilization of AI technology may be increased. It is expected that this will accelerate digital transformation of the manufacturing industry and contribute to improving industrial competitiveness.

The above effects are due to organic combination and systematic operation of the individual components of the present disclosure. Since each of the components, such as the data preprocessing unit, the teaching AI model unit, the data filtering unit, and the model retraining unit, functions effectively, and the data flow between the same is smooth, the entire system forms a virtuous cycle structure. Such an organic structure is the core strength of the present disclosure, and exhibits differentiated effects compared to the conventional technology.

As is apparent from the above description, in a vision inspection system and method according to the present disclosure, detected data is automatically analyzed and a deep learning model is effectively automatically updated using determination result data obtained by the deep learning model, thereby being capable of greatly improving inspection performance, further advancing quality management in the manufacturing industry, and contributing to strengthening industrial competitiveness.

Particularly, in the vision inspection system and method according to the present disclosure, the concept of teaching AI is introduced so that the teaching AI monitors the output of an inspection model and automatically identifies and corrects incorrect determination results, and thereby, an automated feedback system that enables continuous model updates and performance improvement while minimizing human intervention may be provided and implemented.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

What is claimed is:

1. A vision inspection system for vehicle manufacturing, the visual inspection system comprising:
an appearance defect vision inspection apparatus configured to inspect appearance defects using an appearance defect vision inspection artificial intelligence (AI) model based on product image data captured by a camera;
a data storage configured to store inspection data comprising the product image data and determination result data of an appearance defect inspection; and
an AI retraining support inspection apparatus configured to identify incorrect determination data among the determination result data based on the inspection data and the determination result data input from the data storage, and update the appearance defect vision inspection AI model of the appearance defect vision inspection apparatus through a model retraining process performed based on the identified incorrect determination data.

2. The vision inspection system of claim 1, wherein the camera is a vision camera.

3. The vision inspection system of claim 1, wherein the appearance defect inspection is carried out by the appearance defect inspection AI model.

4. The vision inspection system of claim 1, wherein the incorrect determination data is identified using teaching AI models.

5. The vision inspection system of claim 1, wherein the AI retraining support inspection apparatus comprises:
a teaching AI model unit configured to determine whether there are appearance defects of a product and defective states thereof based on the inspection data, acquire and identify the incorrect determination data based on determination results as to whether there are the appearance defects of the product and the defective states thereof and the determination result data by the appearance defect vision inspection apparatus input from the data storage, and correct the identified incorrect determination data.

6. The vision inspection system of claim 5, further comprising:
binary classification teaching AI models provided to acquire the incorrect determination data by determining whether determination results by the appearance defect vision inspection apparatus are incorrectly determined based on the determination results as to whether there are the appearance defects of the product and the defective states thereof by the teaching AI model unit and the determination result data by the appearance defect vision inspection apparatus, and identify the acquired incorrect determination data; and
a multiclass classification teaching AI model configured to correct the identified incorrect determination data and assign a label for each defect type to actually defective data among the corrected data.

7. The vision inspection system of claim 5, wherein the AI retraining support inspection apparatus further comprises:
a data filtering unit configured to filter the identified incorrect determination data and actually defective data among the corrected data to construct a data set to be used for model retraining; and
a model retraining unit configured to retrain and modify the appearance defect vision inspection AI model based on the data set constructed by the data filtering unit.

8. The vision inspection system of claim 5, wherein the AI retraining support inspection apparatus further comprises:
a data preprocessing unit configured to receive the inspection data and the determination result data from the data storage and convert the inspection data and the determination result data into a form processible by the teaching AI models.

9. The vision inspection system of claim 1, wherein the AI retraining support inspection apparatus is provided to transmit the appearance defect vision inspection AI model modified through the model retraining process to the appearance defect vision inspection apparatus to update the appearance defect vision inspection AI model of the appearance defect vision inspection apparatus.

10. A vehicle manufacturing assembly comprising the vision inspection system of claim 1.

11. A vision inspection method for vehicle manufacturing, the visual inspection method comprising:
inspecting, by an appearance defect vision inspection apparatus, appearance defects using an appearance defect vision inspection artificial intelligence (AI) model based on product image data captured by a camera;
transmitting inspection data comprising the product image data and determination result data of an appearance defect inspection to a data storage so that the data storage stores the inspection data and the determination result data; and
identifying, by an AI retraining support inspection apparatus, incorrect determination data among the determination result data using teaching AI models based on the inspection data and the determination result data input from the data storage, and updating the appearance defect vision inspection AI model of the appearance defect vision inspection apparatus through a model retraining process performed based on the identified incorrect determination data.

12. The vision inspection system of claim 11, wherein the camera is a vision camera.

13. The vision inspection system of claim 11, wherein the appearance defect inspection is carried out by the appearance defect inspection AI model.

14. The vision inspection system of claim 11, wherein the incorrect determination data is identified using teaching AI models.

15. The vision inspection method of claim 11, wherein the AI retraining support inspection apparatus determines whether there are appearance defects of a product and defective states thereof based on the inspection data, acquires and identifies the incorrect determination data based on determination results as to whether there are the appearance defects of the product and the defective states thereof and the determination result data by the appearance defect vision inspection apparatus input from the data storage, corrects the identified incorrect determination data, and then performs the model retraining process using the identified incorrect determination data and the corrected data.

16. The vision inspection method of claim 15, wherein the teaching AI models comprise:
binary classification teaching AI models provided to acquire the incorrect determination data by determining whether determination results by the appearance defect vision inspection apparatus are incorrectly determined based on the determination results as to whether there are the appearance defects of the product and the defective states thereof by the teaching AI retraining support inspection apparatus and the determination result data by the appearance defect vision inspection apparatus, and identify the acquired incorrect determination data; and
a multiclass classification teaching AI model configured to correct the identified incorrect determination data and assign a label for each defect type to actually defective data among the corrected data.

17. The vision inspection method of claim 15, wherein the AI retraining support inspection apparatus:
filters the identified incorrect determination data and actually defective data among the corrected data to construct a data set to be used for model retraining; and
retrains and modifies the appearance defect vision inspection AI model based on the data set.

18. The vision inspection method of claim 15, wherein the AI retraining support inspection apparatus receives the inspection data and the determination result data from the data storage, converts the inspection data and the determination result data into a form processible by the teaching AI models, and then uses the converted data in the teaching AI models.

19. The vision inspection method of claim 11, wherein the AI retraining support inspection apparatus transmits the appearance defect vision inspection AI model modified through the model retraining process to the appearance defect vision inspection apparatus to update the appearance defect vision inspection AI model of the appearance defect vision inspection apparatus.

20. A vehicle manufacturing method comprising the vehicle inspection method of claim 11.
